(19) United States
(12) Patent Application Publication
(10) Pub. No.: US 2007/0033224 A1
(43) Pub. Date: Feb. 8, 2007

(54) Method and system for automatic construction and management of sets of hierarchical interest points

(76) Inventors: Richard Barnett Allen, Lago Vista, TX (US); Thomas Alexander Bellwood, Austin, TX (US); Robert Bryant Chumbley, Austin, TX (US); Matthew Francis Rutkowski, Pflugerville, TX (US)

Correspondence Address: IBM CORP (YA);C/O YEE & ASSOCIATES PC, P.O. BOX 802333, DALLAS, TX, 75380, US

(21) Appl. No.: 11/197,619

(22) Filed: Aug. 4, 2005

(51) Int. Cl. G06F 17/00

(52) U.S. Cl. 707/104.1

(57) ABSTRACT

Constructing and managing Sets of Hierarchical Interest Points. Data associated with content from a content provider is provided to a management system. The management system creates the Set of Hierarchical Interest Points based on the data. The Set of Hierarchical Interest Points is used to modify content presented to a user.

### BACKGROUND OF THE INVENTION

1. Field of the Invention

The present invention relates generally to an improved data processing system and in particular to a method and apparatus for processing data. Still more particularly, the present invention relates to constructing and managing data for Sets of Hierarchical Interest Points.

2. Description of the Related Art

The World Wide Web, also referred to as the “Web” has become a readily available and extensive source of information to computer users. However, the explosive growth of the Web and the volume of information available have complicated the task of locating desired information. Users spend increasing amounts of time either performing keyword-based searches on one or more available search engines or traversing links via portal sites in search of the information desired by the users. Additionally, search engine and portal providers commonly only have limited information for use in presenting first-order search results or top-level navigation links. Often, the limited information may be restricted simple keywords provided to the search. At best, a Website might provide site-specific personalization/preferences settings. Once created, these preferences are only available at that Website. Moreover, these preference settings may not capture the full range of interests of the user. Thus, users must still perform manual filtering through search results or navigate through layers of content.

As a practical matter, a content provider has difficulty in foreseeing, at a sufficiently granular level, the potential interests of an individual user. Although a content provider can ask about preferences or interests, the content provider cannot anticipate the nearly unlimited range of interests a group of users might have. Moreover, saving and managing such a large amount of user-interest data is impractical for most Web servers.

### SUMMARY OF THE INVENTION

The aspects of present invention provide a method, apparatus, and computer usable program code for constructing and managing a Set of Hierarchical Interest Points. A content provider or an analyzer provides data associated with content from a content provider to a management system. The management system creates the Set of Hierarchical Interest Points based on the data. The of Hierarchical Interest Points modifies content presented to a user.

### BRIEF DESCRIPTION OF THE DRAWINGS

The novel features believed characteristic of the invention are set forth in the appended claims. The invention itself, however, as well as an illustrative mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in which the present invention may be implemented;

FIG. 3 is a block diagram illustrating a data processing system in which the present invention may be implemented;

FIG. 4 is a block diagram illustrating a system for construction and management of Sets of Hierarchical Interest Points, in accordance with an illustrative embodiment of the present invention;

FIG. 5 is a flowchart of a method of constructing and managing Sets of Hierarchical Interest Points, in accordance with an illustrative embodiment of the present invention;

FIG. 6 is a flowchart of an exemplary method of gathering Sets of Hierarchical Interest Points data, in accordance with an illustrative embodiment of the present invention;

FIG. 7 illustrates an example of a graphical user interface for presenting and managing Sets of Hierarchical Interest Points, in accordance with an illustrative embodiment of the present invention; and

FIG. 8 illustrates an example of a hierarchical interest profile, in accordance with an illustrative embodiment of the present invention.

### DETAILED DESCRIPTION OF THE PREFERRED EMBODIMENT

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connects to network 102 along with storage unit 106. In addition, clients 108, 110, and 112 connect to network 102. These clients 108, 110, and 112 may be, for example, personal computers or network computers. In the depicted example, server 104 provides data, such as boot files, operating system images, and applications to clients 108-112. In these examples the data also may include hierarchical interest points that are managed using processes of the present invention. Clients 108, 110, and 112 are clients to server 104. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

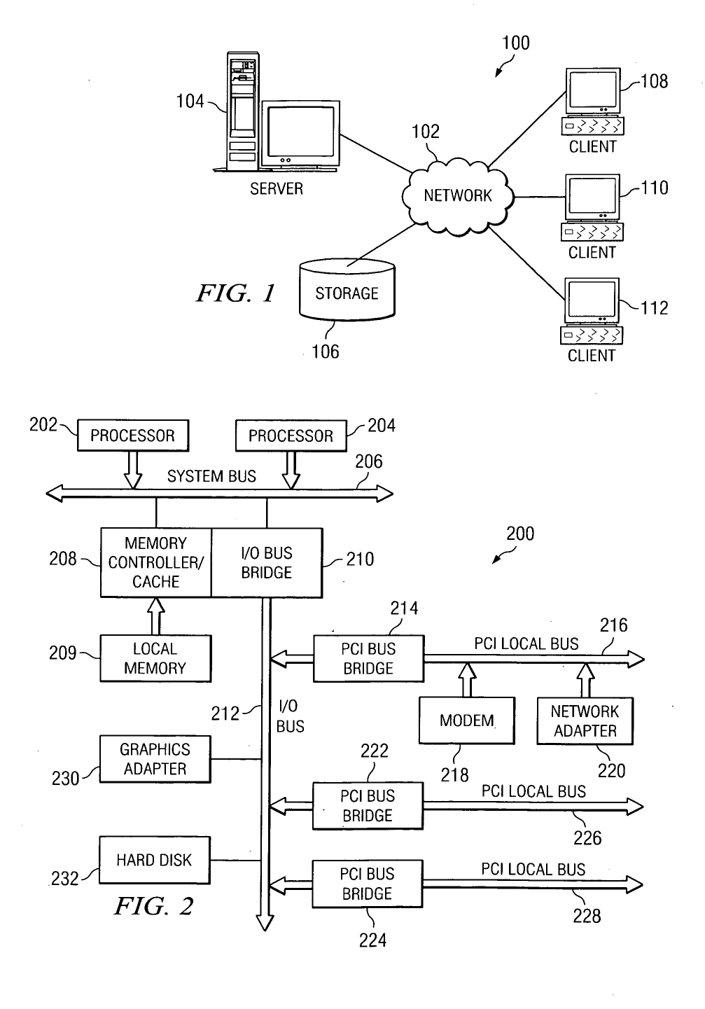

Referring to FIG. 2, a block diagram of a data processing system that may be implemented as a server, such as server 104 in FIG. 1, is depicted in accordance with an illustrative embodiment of the present invention. Data processing system 200 may be a symmetric multiprocessor (SMP) system including a plurality of processors 202 and 204 connects to system bus 206. Alternatively, a single processor system may be employed. System bus 206 connects to memory controller/cache 208, which provides an interface to local memory 209. I/O Bus Bridge 210 connects to system bus 206 and provides an interface to I/O bus 212. Memory controller/cache 208 and I/O Bus Bridge 210 may be integrated as depicted.

Peripheral component interconnect (PCI) bus bridge 214 connects to I/O bus 212 provides an interface to PCI local bus 216. A number of modems may connect to PCI local bus 216. Typical PCI bus implementations will support four PCI expansion slots or add-in connectors. Communications links to clients 108-112 in FIG. 1 may be provided through modem 218 and network adapter 220 connects to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 270 and hard disk 232 may also connect to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer® pSeries® system, a product of International Business Machines Corporation® in Armonk, N.Y., running the Advanced Interactive Executive (AIX®) operating system or LINUX® operating system.

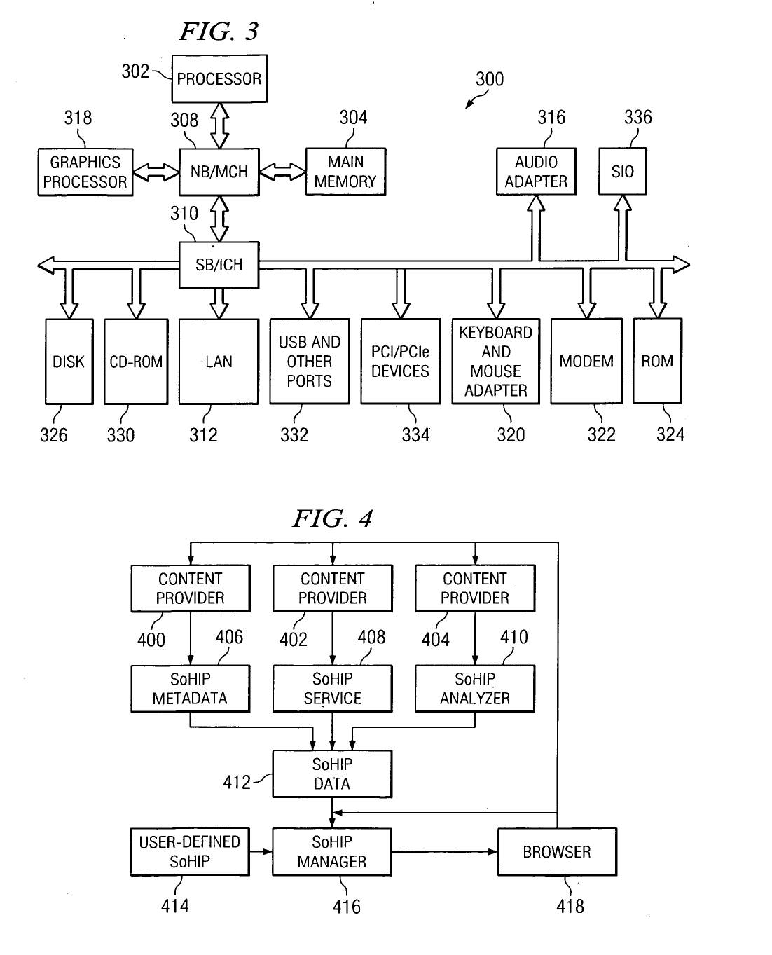

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 connect to PCI local bus 306 through PCI Bridge 308. PCI Bridge 308 also may include an integrated memory controller and cache memory for processor 302. Additional connections to PCI local bus 306 may be made through direct component interconnection or through add-in boards. In the depicted example, local area network (LAN) adapter 310, small computer system interface (SCSI) host bus adapter 312, and expansion bus interface 314 connect to PCI local bus 306 by direct component connection. In contrast, audio adapter 316, graphics adapter 318, and audio/video adapter 319 connect to PCI local bus 306 by add-in boards inserted into expansion slots. Expansion bus interface 314 provides a connection for a keyboard and mouse adapter 320, modem 322, and additional memory 324. SCSI host bus adapter 312 connects to devices, such as hard disk drive 326, tape drive 328, and CD-ROM drive 370.

An operating system runs on processor 302 and coordinates and provides control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded onto a volatile storage device, such as main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. In addition, the processes of the present invention may be applied to a multiprocessor data processing system.

As another example, data processing system 300 may be a stand-alone system configured to be bootable without relying on some type of network communication interfaces. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention provides a method, apparatus, and computer instructions for constructing and managing a Set of Hierarchical Interest Points. A content provider or an analyzer provides data associated with content from a content provider to a management system. The management system creates the Set of Hierarchical Interest Points based on the data. The Set of Hierarchical Interest Points modifies content presented to a user.

FIG. 4 is a block diagram illustrating a system for construction and management of Sets of Hierarchical Interest Points, in accordance with an illustrative embodiment of the present invention. The illustrative embodiment shown in FIG. 4 is implemented in the context of the Internet and the World Wide Web, though the system may be adapted to manage information presented to a user in other contexts. For example, the illustrative system may be used with databases, file systems, other types of computer networks, and similar devices and systems. Thus, the illustrative embodiment shown in FIG. 4 may be implemented in a data processing system, such as client 300 in FIG. 3 or clients 108, 110, and 112, server 200 in FIG. 2 or server 104 in FIG. 1, and may be implemented over a network, such as network 102 in FIG. 1.

In the illustrative embodiment shown in FIG. 4, a user desires to gain access to specific information present in a large amount of content provided by a number of content providers, such as content provider 400, content provider 402, and content provider 404. The illustrative embodiment shown in FIG. 4 automatically sorts the content according to user interests and presents information of most interest to the user.

To accomplish this goal, a Sets of Hierarchical Interest Points (SoHIP) manager 416 analyzes data 412 associated with content accessed by the user via browser 418. Data 412 may be gathered in a number of ways, three of which are shown in FIG. 4, all of which may be used simultaneously. In one illustrative embodiment, browser 418 sends a request for information to content provider 400. Content provider 400 utilizes systems that automatically generate data useful to Sets of Hierarchical Interest Points manager 416 and includes that data as metadata in hypertext markup language (HTML) document header. In this case, the metadata is the Sets of Hierarchical Interest Points data 412 that is provided to Sets of Hierarchical Interest Points manager 416.

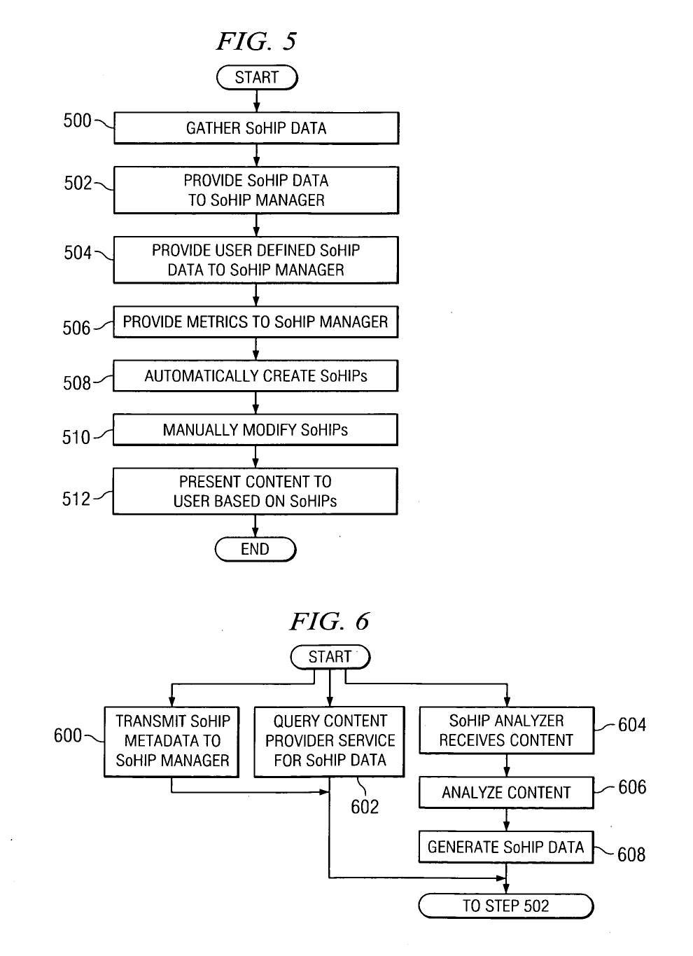

In another illustrative embodiment, browser 418 sends a request for information to content provider 402. Content provider 402 does not automatically generate data useful to Sets of Hierarchical Interest Points manager 416, but does utilize a service 408 that does automatically generate data useful to Sets of Hierarchical Interest Points manager 416. In this case, Sets of Hierarchical Interest Points service 408 generates Sets of Hierarchical Interest Points data 412 based on a number of factors and metrics, as described further in relation to FIG. 5, and provides the Sets of Hierarchical Interest Points data 412 to Sets of Hierarchical Interest Points manager 416.

In a third illustrative embodiment, browser 418 sends a request for information to content provider 404. In this illustrative embodiment, content provider 404 does not automatically generate data useful to Sets of Hierarchical Interest Points manager 416 and does not utilize a Sets of Hierarchical Interest Points service 408. Alternatively, content provider 404 or the Sets of Hierarchical Interest Points service does not provide sufficient data. In this case, a Sets of Hierarchical Interest Points analyzer 410 may be provided as a plug-in program in the client data processing system, or as a service accessed by the client data processing system. The Sets of Hierarchical Interest Points analyzer 410 examines the information requested by the client browser and returned by content provider 404. Thus, the returned information may be any information transmitted from a content provider to a client. The information is analyzed according to a number of factors and metrics, as described further in relation to FIG. 5.

In addition, Sets of Hierarchical Interest Points analyzer 410 may actively explore a website managed by content provider 404, much in the same way that a Webcrawler can explore a Website. After exploring the content provider's Website, the Sets of Hierarchical Interest Points analyzer again analyzes the gathered information according to a number of factors and metrics, as described further in relation to FIG. 5 below. In either case, Sets of Hierarchical Interest Points analyzer produces Sets of Hierarchical Interest Points data 412, and provides Sets of Hierarchical Interest Points data 412 to Sets of Hierarchical Interest Points manager 416.

In addition, a content provider may provide the Sets of Hierarchical Interest Points analyzer 410 and Sets of Hierarchical Interest Points manager 416. With a user's permission, even if tacit, a plug-in program may update browser 418 such that a content provider or a service provider can automatically generate Sets of Hierarchical Interest Points data and manage Sets of Hierarchical Interest Points data for the user. In this case, the Sets of Hierarchical Interest Points service may be provided to the user silently such that the user need not be involved with the process of creating and managing Sets of Hierarchical Interest Points.

Sets of Hierarchical Interest Points data 412 may include any number of types of data, possibly depending on what capabilities the manufacturer imparts to Sets of Hierarchical Interest Points manager 416 and depending on user preferences. In these illustrative examples, a common characteristic shared by Sets of Hierarchical Interest Points data is that Sets of Hierarchical Interest Points a Sets of Hierarchical Interest Points manager 416 may use Sets of Hierarchical Interest Points data to automatically determine a user's interests and present information to the user that is more likely to be of interest to the user. Examples of Sets of Hierarchical Interest Points data include a timestamp of when a Website is first entered, tracked time spent in a Website, the depth to which a user explores a site, the number of links within a Website are selected, the number of times a site is visited in a particular time period, the number of times similar search criteria are entered into a search engine, header information contained in an HTML document, keywords present in an HTML document, file names, features present in a picture, video or music, the number of times a file or type of file is downloaded, and countless other potential types of data.

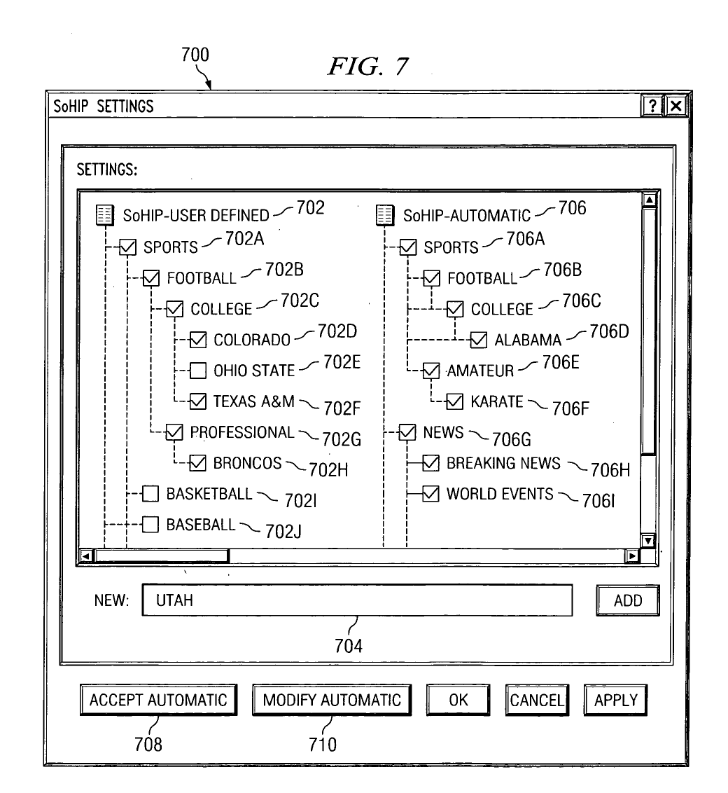

In addition to Sets of Hierarchical Interest Points data 412, which is automatically gathered, Sets of Hierarchical Interest Points manager 416 may also use user-defined preferences 414, such as user-defined preferences or user-supplied data, as part of the data used to create and manage Sets of Hierarchical Interest Points. A user may provide user-defined preferences 414 via a plug-in program to browser 418. In this case, the user is provided with a user interface, such as the one shown in FIG. 7, which allows a user to enter user preferences and define policies. Additionally, a content provider or a manufacturer of Sets of Hierarchical Interest Points manager 416 may provide user-defined preferences 414. In this case, the designated policies or data are downloaded to Sets of Hierarchical Interest Points manager 416 and incorporated into any other user-defined preferences 414.

Further, Sets of Hierarchical Interest Points manager 416 interacts with browser 418 so that Sets of Hierarchical Interest Points manager may automatically gather data regarding the behavior and interests of a user of browser 418. For example, Sets of Hierarchical Interest Points manager 416 can track how long a user spends at a Website, how many links within a Website a user selects, what kind of information a user enters in various on-line forms, or other kinds of information a browser could gather from the behavior of a user.

In use, once Sets of Hierarchical Interest Points manager 416 gathers Sets of Hierarchical Interest Points data 412, has been provided with user-defined preferences 414, or gathers some information from browser 418, Sets of Hierarchical Interest Points manager 416 automatically creates and manages Sets of Hierarchical Interest Points (Sets of Hierarchical Interest Points). Sets of Hierarchical Interest Points manager 416 uses one or more Sets of Hierarchical Interest Points to modify what content a browser displays to a user via browser 418.

For example, the user is interested in sports. From Sets of Hierarchical Interest Points data 412, user-defined preferences 414, or user behavior via browser 418, Sets of Hierarchical Interest Points manager 416 creates a Sets of Hierarchical Interest Points that indicates that the user is particularly interested in American football, and is specifically interested in the Denver Broncos®, and the college football teams from Colorado State University®, Texas A&M®, Alabama University®, as shown in FIG. 7. Thus, when the user accesses a Website that contains information regarding a large number of American football teams, or visits a Website associated with a team, Sets of Hierarchical Interest Points manager 416 automatically parses the information available in the content provider's Website for information related to those teams. The information related to those teams is then preferentially presented to the user.

Furthermore, Sets of Hierarchical Interest Points manager 416 may be provided with the capability of parsing information at a predetermined granularity. For example, the Sets of Hierarchical Interest Points described above regarding American football may be further detailed such that when a user visits a Website associated with the Denver Broncos®, the user is preferentially presented with player statistics. At a higher level of granularity, the user may be preferentially presented with statistics related to a particular player, such as the number of yards rushed, or may be preferentially presented with a particular statistic related to each player, such as the amount of time a player has been on the team.

Should the user desire to view content related to other teams, the user may still view this additional content. Thus, in the illustrative embodiment, Sets of Hierarchical Interest Points manager 416 does not prevent or restrict a user from accessing other content available at a Website. In fact, as a user visits additional Websites, Sets of Hierarchical Interest Points manager continues to update the users Sets of Hierarchical Interest Points or Sets of Hierarchical Interest Points. Thus, when if the user visits a Website related to the Notre Dame Fighting Irish® and stops visiting Websites related to Colorado State University®, then Sets of Hierarchical Interest Points manager 416 may begin to preferentially present information to the user regarding the former team and cease to preferentially present information regarding the latter team.

FIG. 5 is a flowchart of a method of constructing and managing Sets of Hierarchical Interest Points (Sets of Hierarchical Interest Points), in accordance with an illustrative embodiment of the present invention. The method illustrated in FIG. 5 may be implemented in system shown in FIG. 4 and in the data processing systems and the network shown in FIG. 1, FIG. 2, and FIG. 3. More specifically, the method may be further implemented using a Sets of Hierarchical Interest Points manager, such as Sets of Hierarchical Interest Points manager 416 in FIG. 4 in combination with browser 418, and at least one of Sets of Hierarchical Interest Points metadata 406, Sets of Hierarchical Interest Points service 408, Sets of Hierarchical Interest Points analyzer 410, or user-defined Sets of Hierarchical Interest Points parameters 414.

Initially, the process gathers Sets of Hierarchical Interest Points data useful to a Sets of Hierarchical Interest Points manager (step 500). Sets of Hierarchical Interest Points data may be gathered in the manner described in relation to FIG. 4 and FIG. 6, and using the devices described in relation to FIG. 4. Sets of Hierarchical Interest Points data may be the type of data described in relation to Sets of Hierarchical Interest Points data 412 of FIG. 4.

The process then provides all gathered Sets of Hierarchical Interest Points data to a Sets of Hierarchical Interest Points manager (step 502). The Sets of Hierarchical Interest Points manager may be Sets of Hierarchical Interest Points manager 416 described in relation to FIG. 4. Optionally, the process provides user-defined Sets of Hierarchical Interest Points data or policies to the Sets of Hierarchical Interest Points manager (step 504) in the manner described in relation to FIG. 4. In addition, the process also provides metrics to the Sets of Hierarchical Interest Points manager (step 506). The metrics may already be included with the Sets of Hierarchical Interest Points manager as part of a purchased software package, or may be downloaded or updated from a manufacturer-maintained website via a network connection.

Metrics allow the Sets of Hierarchical Interest Points manager to control integration of Sets of Hierarchical Interest Points data into one or more Sets of Hierarchical Interest Points (Sets of Hierarchical Interest Points). Metrics allow a Sets of Hierarchical Interest Points manager to both use Sets of Hierarchical Interest Points data to construct a Sets of Hierarchical Interest Points, and also to weight Sets of Hierarchical Interest Points data such that a browser more prominently features information of greater interest to the user than similar information in a similar information category. Metrics may include the active time spent at a Website,. or time actually spent perusing data; the depth that a site is explored; the number of times a site is visited; the number of times similar search criteria are used in a search engine; user-defined policies and preferences, and other metrics.

From the above examples, metrics are similar to Sets of Hierarchical Interest Points data. However, the difference between metrics and Sets of Hierarchical Interest Points data is that data are raw pieces of information, whereas metrics specify how raw pieces of information are to be used. For example, Sets of Hierarchical Interest Points data might specify that a user has visited the Website for the Denver Broncos® twenty times in the last five days. A corresponding metric specifies that any Website that has been visited more than fifteen times in five days contains information that has a high interest value to the user. The Sets of Hierarchical Interest Points manager correlates the metric and the data, determines that the Website is of high interest value to the user, and modifies presentation of content from the Website accordingly. For example, the Website may feature prominently when displayed or a hot button may appear in the browser that, when pressed, takes the user to the website. Similarly, a metric may specify that if a Website has not been visited in thirty days, that the Website is of lower interest value to the user, and presentation of content from the Website will be modified accordingly. Thus, metrics may be automatically and dynamically updated as a user browses the Internet.

The interest value of a Website or of a particular type of content may be weighted using a numerical value in the illustrative embodiments. For example, an interest value may vary between −10 and 10. Content or Websites with an interest value of −10 designate content or Websites that a user wishes to avoid. Content or Websites with an interest value of 10 designate content or Websites in which a user is most interested. In addition, the interest value of a Website may be strictly keyword-based. In either case, a user may designate the interest value of any particular Website, content, or type of content, or metrics may determine automatically the interest value of any particular Website in the manner described above.

Turning back to FIG. 5, once metrics are provided to the Sets of Hierarchical Interest Points manager, the Sets of Hierarchical Interest Points manager automatically creates Sets of Hierarchical Interest Points (Sets of Hierarchical Interest Points) (step 508). Optionally, a user may manually specify one or more of the Sets of Hierarchical Interest Points (step 510). Once established, the process uses Sets of Hierarchical Interest Points to modify information contained in the content of a Website and to present the modified content to a user (step 512). Modifying the presentation of content may include, for example, sorting or parsing content for information of higher interest value than other information present in the content; filtering information of little, no, or negative interest to a user; presenting content information more prominently; creating hot buttons in a Web browser to high interest Websites; or otherwise modifying the presentation of information or content downloaded from a Website. Thereafter, the process terminates.

FIG. 6 is a flowchart of an exemplary method of performing step 500 in FIG. 5, in accordance with an illustrative embodiment of the present invention. Thus, FIG. 6 shows in more detail a method of gathering Sets of Hierarchical Interest Points data for use in a Sets of Hierarchical Interest Points manager.

As described in relation to FIG. 4, several sources may provide Sets of Hierarchical Interest Points data. For example, a content provider may transmit Sets of Hierarchical Interest Points metadata in the header of an HTML document (step 600). Thereafter, the process returns to step 502 of FIG. 5.

A service provider may also transmit Sets of Hierarchical Interest Points metadata separately, place Sets of Hierarchical Interest Points metadata in other areas of an HTML document, or transmit Sets of Hierarchical Interest Points metadata in other data packets or in other forms. However provided, a content provider provides Sets of Hierarchical Interest Points metadata in a format the Sets of Hierarchical Interest Points manager may readily use. Thus, for example, if a user browses a predetermined number of links in a Website or if the user grants a content provider permission by selecting a particular link, then the content provider will transmit Sets of Hierarchical Interest Points metadata to the Sets of Hierarchical Interest Points manager. The Sets of Hierarchical Interest Points metadata will indicate that the Website or a particular type of information present in the Website is of a predetermined interest value.

In addition, perhaps simultaneously, the process may query the content provider service for Sets of Hierarchical Interest Points data (step 602). In step, 602, the content provider may use a separate service to provide Sets of Hierarchical Interest Points data to the Sets of Hierarchical Interest Points. Thereafter, the process returns to step 502 of FIG. 5.

In this case, when a client browser accesses a Website, the content provider also routs the content request to a Sets of Hierarchical Interest Points provider. In turn, based on metrics specified by the content provider, by the Sets of Hierarchical Interest Points manager, or by the user, the Sets of Hierarchical Interest Points provider transmits Sets of Hierarchical Interest Points data to the Sets of Hierarchical Interest Points manager. Alternatively, a client browser may directly query a content provider operating a Sets of Hierarchical Interest Points service for Sets of Hierarchical Interest Points data. Thus, Sets of Hierarchical Interest Points data is not automatically transmitted to the client, but rather only at the request of the client. In yet another example, a client browser may directly query a Sets of Hierarchical Interest Points provider service. In this case, the service provider monitors the client's Web-browsing behavior and provides Sets of Hierarchical Interest Points data to the Sets of Hierarchical Interest Points manager accordingly. Thus, the content provider, a third party provider, or a user on a client data processing system may manage the Sets of Hierarchical Interest Points provider.

In addition, perhaps simultaneously, a client, a content provider, or a Sets of Hierarchical Interest Points provider may operate or manage a Sets of Hierarchical Interest Points analyzer. The Sets of Hierarchical Interest Points analyzer monitors the activity of a client browser and receives content the browser accesses (step 604). The Sets of Hierarchical Interest Points analyzer then analyzes the content according to metrics, as described in relation to FIG. 5 and elsewhere (step 606). The Sets of Hierarchical Interest Points analyzer then generates Sets of Hierarchical Interest Points data and provides the Sets of Hierarchical Interest Points data to the Sets of Hierarchical Interest Points manager (step 608). Thereafter, the process returns to step 502 of FIG. 5.

FIG. 7 illustrates an example of a graphical user interface (GUI) for presenting and managing hierarchical interest points, in accordance with an illustrative embodiment of the present invention. The system shown in FIG. 4 may generate GUI 700 shown in FIG. 7 according to the process shown in FIG. 5 and FIG. 6.

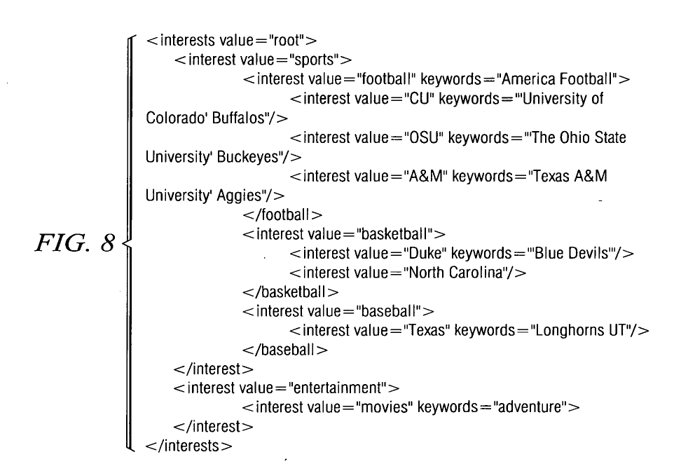

GUI 700 is in the form of a dialog window commonly found on personal computers and workstations. GUI 700 presents Sets of Hierarchical Interest Points 702 and Sets of Hierarchical Interest Points 706 as tree-based lists. Checkboxes 702A through 702J effect manual selection and deselection of interests and subinterests in Sets of Hierarchical Interest Points 702. Typically, checkboxes toggle in response to mouseclicks while a cursor is positioned over the checkbox. An XML document, such as that shown in FIG. 8, representing the data may be populated using the selections in GUI 700 and sent to a Web portal or search engine, as described further below. Thus, an XML Sets of Hierarchical Interest Points representation corresponding to the selections in GUI 700 would have interest nodes with the values “Sports,” “Football,” “College,” with sub-interests “Colorado,” “Texas A&M,” “Professional,” with sub-interest “Broncos,” corresponding, respectively to selected checkboxes 702A, 702B, 702C, 702D, 702F, 702G and 702H. In this way, deselecting checkboxes in the GUI tree, illustrated by checkboxes 702E, 702I, and 702J, may restrict a search to a subset of a user's interests. Additionally, a user may add new interest via text entry field 704. Additionally, a user may specify additional Sets of Hierarchical Interest Points, in addition to Sets of Hierarchical Interest Points 702 and Sets of Hierarchical Interest Points 706, via text entry field 704.

Additionally, GUIs such as that shown in FIG. 7 may include other techniques commonly used in the data processing art to insert and modify Sets of Hierarchical Interest Points data. These techniques include “drag-and-drop” manipulation of interests, and menu selections, among others. Further, interprocess communication APIs found in modern operating systems provide a mechanism by which a mouseclick or similar user input action may add a word or phase displayed on a browser to add the word or phrase to Sets of Hierarchical Interest Points 702 “on the fly.”

Although GUI 700 provides a convenient technique for managing Sets of Hierarchical Interest Points, alternative mechanisms may be used to manipulate Sets of Hierarchical Interest Points. These include text editors and XML editors. In addition, Sets of Hierarchical Interest Points may be generated and presented automatically, as described above.

The illustrative embodiment shown in FIG. 7, displays a separate Sets of Hierarchical Interest Points 706 to reflect an automatically generated Sets of Hierarchical Interest Points 706. Automatically generated Sets of Hierarchical Interest Points 706 shows a Sets of Hierarchical Interest Points that may be created by the system shown in FIG. 4 according to the methods described in FIG. 5 and FIG. 6. In this case, the browser or the content provider tracks the user's behavior while “surfing” Websites and the Sets of Hierarchical Interest Points manager creates a corresponding Sets of Hierarchical Interest Points 706. Again, GUI 700 presents Sets of Hierarchical Interest Points 706 in the form of a tree showing different degrees of granularity. Thus, a broad interest topic is “sports” 706A, under which is “Football” 706B, under which is “College” 706C, under which is “Alabama” 706D. Similarly, “Amateur” 706E is a subcategory of “Sports” 706A and “Karate” 706F is a subcategory of “Amateur” 706E. In addition, based on user behavior, the Sets of Hierarchical Interest Points manager automatically creates a new broad category of “News” 706G, with sub-categories of “Breaking News” 706H and “World Events” 7061.

A user may modify Sets of Hierarchical Interest Points 706. For example, a user may toggle checked boxes, as described above, thereby manually designating that the particular topic is no longer of interest. The user may also modify Sets of Hierarchical Interest Points 706 in other ways, such as by designating that a particular type of content is only of interest if the content has been posted for less than a predetermined time. Thus, for example, in the sub-category of “Breaking News” 706H, the Sets of Hierarchical Interest Points manager further modifies Sets of Hierarchical Interest Points 706H such that only content that has been posted for less than an hour is of interest. Another way to manually modify Sets of Hierarchical Interest Points 706 is to manually add a broad category via dialog box 704. The Sets of Hierarchical Interest Points manager may be programmed to add corresponding subcategories automatically after the broad category has been added. In addition, hot buttons may modify automatically generated Sets of Hierarchical Interest Points 706, such as “Accept Automatic” button 708 and “Modify Automatic” 710. The “Accept Automatic” button 708, when actuated, will transmit a command to the Sets of Hierarchical Interest Points manager to accept all automatically generated Sets of Hierarchical Interest Points. The “Modify Automatic” button 710, when actuated, will transmit a command to cause a new dialog box to appear that will allow a user to specify advanced settings, such as the timestamp described with respect to “Breaking News” category 706H. In addition, the GUI may present information regarding why a particular Sets of Hierarchical Interest Points or Sets of Hierarchical Interest Points interest was added so that the user may better understand how to modify the overall performance of a Sets of Hierarchical Interest Points. Thus, a variety of different means to modify an automatically generated Sets of Hierarchical Interest Points may be provided.

Furthermore, the Sets of Hierarchical Interest Points manager may use both user-defined Sets of Hierarchical Interest Points 702 and automatically generated Sets of Hierarchical Interest Points 706 at the same time. In an illustrative embodiment the Sets of Hierarchical Interest Points manager combines all Sets of Hierarchical Interest Points, such as Sets of Hierarchical Interest Points 702 and Sets of Hierarchical Interest Points 706., when searching for content or modifying content presented to the user. Categories are added at each level, if necessary, though not duplicated. Thus, if Sets of Hierarchical Interest Points 702 and 706 are combined, one Sets of Hierarchical Interest Points will have a “Sports” broad category, under which will be “Football”, “Professional” from Sets of Hierarchical Interest Points 702 and “Amateur” from Sets of Hierarchical Interest Points 706.

In addition, GUI 700 may be further modified to show all combined Sets of Hierarchical Interest Points. Thus, GUI 700 may display a combined tree to a user. Furthermore GUI 700 may be modified to show Sets of Hierarchical Interest Points in a variety of formats. Thus, GUI 700 may show Sets of Hierarchical Interest Points in a nested format, a folder format, a map-link format, or a variety of other formats.

FIG. 8 illustrates an example of a Set of Hierarchical Interest Points data structure, in accordance with an illustrative embodiment of the present invention. The system shown in FIG. 4 may generate the Sets of Hierarchical Interest Points data structure shown in FIG. 8 according to the methods shown in FIG. 5 and FIG. 6 and the GUI shown in FIG. 7 may display the Sets of Hierarchical Interest Points to a user.

As described above, a Set of Hierarchical Interest Points may refine a user's searches for Web content and also modify content presented to a user. The Sets of Hierarchical Interest Points data structure shown in FIG. 8 is a hierarchical organization of interest metadata. The hierarchy captures the user's preferences for how interest data is to be organized or categorized. As the user's Sets of Hierarchical Interest Points data is traversed from root to leaf nodes, each level of the tree represents a user specific grouping of interests at increasing levels of granularity. Content providers can use the hierarchical presentation to construct and organize content that best matches the user's specific interests, at various levels of granularity.

The illustrative Sets of Hierarchical Interest Points data structure shown in FIG. 8 is as an XML (Xtensible Markup Language) document showing the data structure for Sets of Hierarchical Interest Points 702 of FIG. 7. XML, for which the World Wide Web Consortium (W3C) promulgates standards, is a tag-based markup language for describing structures data. The XML tags <interests> and </interests> wrap a set of user-defined interest keyword value pairs. However, the Sets of Hierarchical Interest Points manager may automatically generate tags while automatically generating a Sets of Hierarchical Interest Points. The “<interest value=“root”>” tag represents the root node in the hierarchy, and has the value “root.” Each interest represents a node in the Sets of Hierarchical Interest Points hierarchy, and defines a nested set of user-specified interest elements represented by the associated value.

Thus, “toplevel” or broad interests include “sports” and “entertainment.” Continuing down the hierarchy, interest nodes further refine the user's interests within each of the broad interests. Within the “sports” interest, three interests are defined: “football,” “basketball,” and “baseball.” Keywords attributes provide a mechanism for the user to specify terminology that may be used to describe the particular interest. Thus, the user's interest “football” may, alternatively be described as “American football.” The user's interest in football is further refined by the three interests nodes having the values “CU,” “OSU,” and “A&M,” respectively. Keywords associate the terminology “‘University of Colorado”’ and “Buffalos” with the corresponding interests. Similarly, keyword values “‘The Ohio State University”’ and “Buckeyes,” and keywords values “‘Texas A&M university”’, and “Aggies” are associated with the corresponding interest.

In the Sets of Hierarchical Interest Points data structure shown in FIG. 8, spaces act as a list separator for keyword attribute value lists. Additionally, single quotes act as enclosing characters to set off a phrase used as a single keyword value. An end tag, denoted using the “backlash” character in accordance with the XML specification, encloses each level in the hierarchy. These illustrations comply with the rules for well-formed XML, including the multiple forms allowable for the treatment of end-tags. These schemes are illustrative, and a user may use other conventions to create the data structure for Sets of Hierarchical Interest Points 702.

The above Sets of Hierarchical Interest Points are described in relation to presenting web-based content in a Web browser. However, the method of generating Sets of Hierarchical Interest Points described above may be used in other data processing environments, as well. For example, user-defined or automatically generated Sets of Hierarchical Interest Points may modify the presentation of large networks of data processing systems. Similarly, user-defined or automatically generated Sets of Hierarchical Interest Points may modify presentation of a file system on an individual data processing system. In another example, presentation of local system components, such as a device manager or file manager, may be modified using Sets of Hierarchical Interest Points. For audio content, lyrics, performance data, or instrumentation may be analyzed and used as metrics in a Sets of Hierarchical Interest Points. In addition, Sets of Hierarchical Interest Points may modify the presentation of email, blogs, discussion boards, and videos. In addition, a Sets of Hierarchical Interest Points may be used in conjunction with an indexing system to use links from created indices. Thus, Web pages having preferred links may be created using Sets of Hierarchical Interest Points. Thus, the mechanism of the present invention may be applied to many different methods and systems for presenting information to a user.

Thus, with the mechanism of the present invention, a user need not manually specify all of a user's preferences. Sets of Hierarchical Interest Points will be generated simply by use of the browser. In addition, the mechanism of the present invention allows a user to exclude information that is not of interest and to preferentially present information that is of interest. Thus, the time required to perform a search for information is reduced.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer-implemented method of constructing a Set of Hierarchical Interest Points, said method comprising:
identifying data associated with content from a content provider to form identified data; and
sorting the data according to a set of metrics to create the Set of Hierarchical Interest Points, wherein the Set of Hierarchical Interest Points is used to access content for a user.

2. The computer-implemented method of claim 1 further comprising:
responsive to user activities, modifying the Set of Hierarchical Interest Points based on the user activities.

3. The computer-implemented method of claim 1 further comprising:
responsive to a user request for the content, using the Set of Hierarchical Interest Points to access and identify the content to form identified content; and
sending the identified content to the user.

4. The computer-implemented method of claim 1, wherein the identifying step and the sorting step are implemented Set of Hierarchical Interest Points manager.

5. A computer-implemented method of constructing a Set of Hierarchical Interest Points, said method comprising:
gathering data associated with content provided by a content provider;
providing the data to a management system; and
creating the Set of Hierarchical Interest Points with the management system by sorting the data according to a set of metrics.

6. The computer-implemented method of claim 5 further comprising:
modifying the content according to the Set of Hierarchical Interest Points to form modified content; and
presenting the modified content to a user.

7. The computer-implemented method of claim 6 wherein the step of modifying the content further comprises adding links to the modified content.

8. The computer-implemented method of claim 5 further comprising:
providing user-defined parameters to the management system, and wherein the step of creating the Set of Hierarchical Interest Points comprises creating the Set of Hierarchical Interest Points with the management system by further sorting the data according to the user-defined parameters.

9. The computer-implemented method of claim 5 wherein the metrics are selected from the group consisting of an active time spent at a Website, a depth a Website is surfed, a number of times a Website is visited, and a number of times similar search criteria are used in at least one search engine.

10. The computer-implemented method of claim 5 wherein the content comprises a plurality of emails and wherein the step of creating the Set of Hierarchical Interest Points involves selecting a group of preferred emails.

11. The computer-implemented method of claim 5 wherein the step of creating the Set of Hierarchical Interest Points comprises creating the Set of Hierarchical Interest Points by sorting the data according to a time stamp associated with the data.

12. A computer program product comprising:
a computer usable medium having computer usable program code for constructing a Set of Hierarchical Interest Points, said computer program product including:
computer usable program code for gathering data associated with content provided by a content provider;
computer usable program code for providing the data to a management system; and
computer usable program code for creating the Set of Hierarchical Interest Points with the management system by sorting the data according to a set of metrics.

13. The computer program product of claim 12 further comprising:
computer usable program code for modifying the content according to the Set of Hierarchical Interest Points to form modified content; and
computer usable program code for presenting the modified content to a user.

14. The computer program product of claim 13 wherein the computer usable program code for modifying the content further comprises computer usable program code for adding links to the modified content.

15. The computer program product of claim 12 further comprising:
computer usable program code for providing user-defined parameters to the management system, and wherein the computer usable program code for creating the Set of Hierarchical Interest Points comprises computer usable program code for creating the Set of Hierarchical Interest Points with the management system by further sorting the data according to the user-defined parameters.

16. The computer program product of claim 12 wherein the metrics are selected from the group consisting of an active time spent at a Website, a depth a Website is surfed, a number of times a Website is visited, and a number of times similar search criteria are used in at least one search engine.

17. The computer program product of claim 12 wherein the content comprises a plurality of emails and wherein the computer usable program code for creating the Set of Hierarchical Interest Points includes computer usable program code for selecting a group of preferred emails.

18. The computer program product of claim 12 wherein the computer usable program code for creating the Set of Hierarchical Interest Points comprises computer usable program code for creating the Set of Hierarchical Interest Points by sorting the data according to a time stamp associated with the data.
